(19) United States
(12) Patent Application Publication
(10) Pub. No.: US 2016/0237256 A1
(43) Pub. Date: Aug. 18, 2016

(54) ELASTOMERIC COMPOSITIONS COMPRISING VINYL ACETAL POLYMERS

(71) Applicant: Eastman Chemical Company, Kingsport, TN (US)

(72) Inventors: Pruthesh Hariharrao Vargantwar, Kingsport, TN (US); Frederick Ignatz Hoover, Elyria, OH (US); Soumendra Kumar Basu, Copley, OH (US); Bradley James Helmer, Kingsport, TN (US); Christopher George Robertson, Parma, OH (US)

(73) Assignee: Eastman Chemical Company, Kingsport, TN (US)

(21) Appl. No.: 15/019,995

(22) Filed: Feb. 10, 2016

Related U.S. Application Data
(60) Provisional application No. 62/115,377, filed on Feb. 12, 2015.

(51) Int. Cl. C08L 9/06

(52) U.S. Cl. CPC C08L 9/06; C08L 2205/02; C08L 2205/03

(57) ABSTRACT

An elastomeric composition is provided comprising at least one elastomeric compound, at least one vinyl acetal polymer, at least one filler, and optionally at least one coupling agent. A process of making the elastomeric composition is also provided as well as articles comprising the elastomeric composition. In particular, tires comprising the elastomeric composition are provided wherein the handling and processing characteristics are improved while other performance characteristics are retained.

### CROSS REFERENCE TO RELATED APPLICATIONS

This application claims priority to U.S. Provisional Application Ser. No. 62/115,377 filed Feb. 12, 2015, the disclosure of which is herein incorporated by reference in its entirety.

### FIELD OF THE INVENTION

The invention belongs to the field of elastomeric compositions comprising at least one elastomer, at least one vinyl acetal polymer, at least one filler, and optionally at least one coupling agent. Processes for producing the elastomeric compositions are also provided as well as articles produced utilizing the elastomeric compositions, in particular, tires.

### BACKGROUND OF THE INVENTION

Tire formulations containing filler can be difficult to process due to their high viscosities at processing conditions. Silica and/or carbon black are often used as fillers in these formulations. For example, the surfaces of the precipitated silica nanoparticles are very polar leading to strong filler-filler interactions and agglomeration, and this behavior is a major contributor to the difficult processing of silica-filled rubber. Long mixing times and or repeated mixing cycles are mostly required to make these formulations usable in elastomeric and tire applications.

To overcome this shortcoming, processing aids, such as, oil are often included in these formulations that help mixing by diluting the elastomeric composition. Alternatively, reduced filler loadings can be used. Although these approaches improve processing, significant negative impacts on the performance properties of the final vulcanized tire compound are seen, which depending on end-use application conditions include reduced tire wear resistance, grip/traction and cornering coefficient (CC) or handling.

By incorporating processing aids such as oils, for example, treated distillate aromatic extract (TDAE) and soaps in tire compounds their processing can be improved. However, addition of soaps and oils often degrade performance of the final vulcanized tire compound by negatively affecting its dynamic mechanical properties. Alternatively, silica coupling agents can be included in the tire compound. However, the problem of long processing times still exists.

Handling can be improved by addition of crosslinking resins, for example, resins crosslinked typically by methylene donors. While in processing, the resin can act as a processing aid, but later in the presence of a crosslinking agent can crosslink with itself during the rubber vulcanization step to form high T_{g} domains, thereby stiffening (increasing low strain modulus: G′ if measured in shear or E′ if measured in tensile modes of testing) of the compound. Increased G′ indicates better handling and cornering characteristics in tread compounds.

Although processing aids, such as oil used in silica formulations, help in compound mixing primarily through compound dilution, they reduce the E′ of the compound and increase its hysteretic behavior consequently deteriorating its rolling resistance. In general, coupling agents can maintain good rolling resistance characteristics, but also negatively affect E′ of the final compound thus worsening the tire handling characteristics.

While the crosslinking resins improve handling characteristics of the final vulcanized compound, the performance can gradually drop due to slow degradation of the resin network under cyclic strains encountered during the lifetime of the tire. This also can result in increased hysteretic behavior and poor rolling resistance. Besides these drawbacks, the use of crosslinking resins can come with environmental concerns of formaldehyde release over a period of time.

There is a need in the industry for additives for elastomeric compositions containing fillers that can enhance processibility without harming performance characteristics of the elastomeric composition.

### BRIEF SUMMARY OF THE INVENTION

In one embodiment of the invention, an elastomeric composition is provided comprising at least one elastomer, at least one vinyl acetal polymer, at least one filler, and optionally at least one coupling agent.

In another embodiment of the invention, a process to produce an elastomeric composition is provided. The process comprises mixing at least one elastomer, at least one vinyl acetal polymer, at least one filler, and optionally at least one coupling agent to produce an elastomeric composition.

In yet another embodiment of the invention, an article is provided comprising an elastomeric composition; wherein the elastomeric composition comprises at least one elastomer, at least one vinyl acetal polymer, at least one filler, and optionally at least one coupling agent. Specifically, a tire is provided comprising the elastomeric composition.

### BRIEF DESCRIPTION OF THE FIGURES

FIG. 1 shows performance of tire tread compounds containing vinyl acetal polymers compared to comparative examples.

### DETAILED DESCRIPTION

An elastomeric composition is provided comprising at least one elastomer, at least one vinyl acetal polymer, at least one filler and optionally at least one coupling agent.

The term “elastomer,” as used herein, can be used interchangeably with the term “rubber.” Due to the wide applicability of the process described herein, the vinyl acetal polymers can be employed with virtually any type of elastomer. For instance, the elastomers utilized in this invention can comprise a natural rubber, a modified natural rubber, a synthetic rubber, and mixtures thereof.

In some embodiments of this invention, the elastomer can be a polar rubber compound. The polar elastomer can be at least one selected from the group consisting of chlorinated rubbers, nitrile rubbers, polyacrylate rubbers, ethylene acrylic rubbers, and polyurethanes.

In certain embodiments of the present invention, at least one of the elastomers is a non-polar elastomer. For example, a non-polar elastomer can comprise at least about 90, 95, 98, 99, or 99.9 weight percent of non-polar monomers. In one embodiment, the non-polar elastomer is primarily based on a hydrocarbon. Examples of non-polar elastomers include, but are not limited to, natural rubber, polybutadiene rubber, polyisoprene rubber, butyl rubber, styrene-butadiene rubber, polyolefins, ethylene propylene monomer rubber (EPM), ethylene propylene diene monomer (EPDM) rubber, and polynorbornene rubber. Examples of polyolefins include, but are not limited to, polybutylene, polyisobutylene, and ethylene propylene rubber. In another embodiment, the elastomer comprises a natural rubber, a styrene-butadiene rubber, and/or a polybutadiene rubber. Non-polar elastomers are often used in tire components.

In certain embodiments, the elastomer contains little or no nitrile groups. As used herein, the elastomer is considered a “non-nitrile” elastomer when nitrile monomers make up less than 10 weight percent of the elastomer. In one embodiment, the elastomer contains no nitrile groups.

In an embodiment of the invention, diene rubbers are utilized having an iodine number of between about 20 to about 400. Illustrative of the diene rubbers that can be utilized are polymers based on conjugated dienes, such as, for example, 1,3-butadiene; 2-methyl-1,3-butadiene; 1,3-pentadiene; 2,3-dimethyl-1,3-butadiene; and the like, as well as copolymers of such conjugated dienes with monomers, such as, for example, styrene, alpha-methylstyrene, acetylene (vinyl acetylene), acrylonitrile, methacrylonitrile, methyl acrylate, ethyl acrylate, methyl methacrylate, ethyl methacrylate, vinyl acetate, and the like. In one embodiment, highly unsaturated rubbers include natural rubber, cis-polyisoprene, polybutadiene, poly(styrene-butadiene), styrene-isoprene copolymers, isoprene-butadiene copolymers, styrene-isoprene-butadiene tripolymers and like. Moreover, mixtures of two or more highly unsaturated rubbers with elastomers having lesser unsaturation such as EPDM, EPR, butyl or halogenated butyl rubbers are also within the contemplation of the invention. These later elastomers may also make a major component of the elastomer mix. At least one of the elastomers (or the elastomer if not a mixture) is a non-polar elastomer. For example, a non-polar primary elastomer can comprise at least about 90, 95, 98, 99, or 99.9 weight percent of non-polar monomers.

The elastomeric diene polymers usable the elastomer in the present invention may be selected from those commonly used in sulfur, peroxide or metal peroxide vulcanizable elastomeric compositions, particularly suitable for tire manufacture. In one embodiment, unsaturated chain elastomeric polymers or copolymers having a glass transition temperature generally lower than 20° C. can be utilized. In other embodiments, the glass transition temperature is between about 0° and about −90° C. Such polymers or copolymers may be of natural origin or may be obtained synthetically by solution or emulsion polymerization of one or more conjugated diolefins, possibly mixed with one or more monovinylarenes in an amount generally not higher than 50% by weight. The elastomer can contain little or no nitrile/halogenated groups.

The vinyl acetal polymers utilized in the elastomeric composition can be any that is known in the art. These polymers can be made by hydrolyzing poly(vinyl acetate) to poly(vinyl alcohol) and the reaction of the latter with an aldehyde in the presence of an acid catalyst. These two reactions, hydrolysis and acetalization, can be conducted either sequentially or concurrently. The acetalization reaction shown below strongly favors complete condensation of one molecule of aldehyde with the 1,3-glycol of two vinyl alcohol units of poly(vinyl alcohol) to form the 1,3-dioxane ring of one vinyl acetal unit.

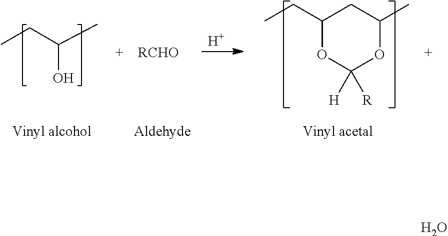

In general, vinyl acetal polymer structure is shown as in Formula 1 below.

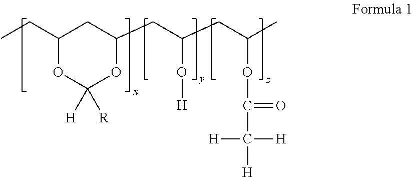

The R group can be hydrogen or a linear or branched alkyl functionality having from 1 to 5 carbons atoms.

Various embodiments of the invention are shown in Table 1 indicating the possible compositions of vinyl acetal polymers in the rubber formulations of this invention. The vinyl acetal polymer can include monomer units containing a weight percentage of vinyl acetal, vinyl alcohol, and vinyl acetate.

| R = | Any | H | Pr |
|---|---|---|---|
| Name | Poly(vinyl | Poly(vinyl | Poly(vinyl |
| | acetal) | formal) | butryal) |
| Abbreviation | — | PVF | PVB |
| Embodiment 1 | | | |
| Wt % vinyl acetal (x) | 25-95 | 25-95 | 25-95 |
| Wt % vinyl alcohol (y) | 2-40 | 2-40 | 2-40 |
| Wt % vinyl acetate (z) | 0-40 | 0-40 | 0-40 |
| Embodiment 2 | | | |
| Wt % vinyl acetal (x) | 70-95 | 75-90 | 75-90 |
| Wt % vinyl alcohol (y) | 4-25 | 5-7 | 10-22 |
| Wt % vinyl acetate (z) | 0-15 | 6-15 | 0-5 |
| Embodiment 3 | | | |
| Molecular Wt (kDa) | 1-600 | 1-500 | 1-600 |
| Embodiment 4 | | | |
| Molecular Weight (kDa) | 10-500 | 10-300 | 10-500 |
| Embodiment 5 | | | |
| Molecular Weight (kDa) | 20-300 | 20-150 | 30-300 |

A minor component of an ionizable or ionic comonomer may be present in the vinyl acetal polymers.

The amount of vinyl acetal polymer can range from about 1 to about 30 phr, from about 2 to about 15 phr, and from about 2 to about 7 phr.

The acetal polymers can contain additives such as plasticizers, stabilizers (antioxidants, IR or UV absorbers etc.) anti-blocking agents, compatibilizers, crosslinkable resins, and crosslinkers as well as many other additives known to one skilled in the art.

A wide variety of plasticizers are suitable for vinyl acetal polymers. For example, PVB can include one or more plasticizers in the amount of 0.1 to 50 wt % of PVB. Any plasticizer or mixture of plasticizers known to those skilled in the art for use with PVB resin can be used. For many years, the universally used plasticizer for PVB was triethylene glycol di(2-ethylbutyrate). More recently, this has been supplanted by triethylene glycol di(2-ethylhexanoate), tetraethylene glycol diheptanoate, dihexyl adipate, 2-ethylhexyl diphenyl phosphate, and a variety of other oligomeric ethylene glycol esters and ethers, and other adipate, phosphate, phthalate, sebacate, and ricinoleate esters. For PVF, diethyl, diphenyl, and dicyclohexyl phthalates, as well as tributyl, triphenyl, and tricresyl phosphates are useful plasticizers. By proper choice of plasticizer type and level, the physical-mechanical, chemical, and adhesion properties of the vinyl acetal polymers can be tailored for a wide variety of applications. A list of plasticizers is also disclosed in U.S. Pat. No. 4,902,464, col. 5, lines 11-21, herein incorporated by reference.

Commercial PVB grades that are appropriate for the applications in this invention include, but not limited to, Butvar® PVB (Eastman Chemical Company), Butacite® PVB (DuPont), Mowital® PVB (Kuraray), PioloformB® (Wacker), and S-Lec® PVB (Sekisui).

The filler in the elastomeric composition of this invention can be any that is known in the art. The amount of filler in the elastomeric composition can range from about 1 to about 400 phr. In other embodiments, the amount of filler can range from about 5 to about 200 phr, from about 20 to about 150 phr, and from about 50 to about 120 (phr=parts by weight per 100 parts of rubber). The filler may be selected from those commonly employed for crosslinked products, and in particular for tires, such as, silica, carbon black, clay, alumina, talc, mica, discontinuous fibers including cellulose fibers and glass fibers, aluminum silicate, aluminum trihydrate, barites, feldspar, nepheline, antimony oxide, calcium carbonate, kaolin, and combinations thereof. In some embodiments, the filler is carbon black, silica, inorganic and nonpolymeric material or mixtures thereof.

Examples of suitable silica fillers include, but are not limited to, precipitated silicas, amorphous silicas, vitreous silicas, fumed silicas, fused silicas, pre-treated silicas, synthetic silicates, such as, aluminum silicates, alkaline earth metal silicates, such as, magnesium silicates and calcium silicates, natural silicates, such as, kaolins and other naturally occurring silicas and the like. Also, useful are highly dispersed silicas having surface areas from about 5 to about 1000 m²/g or from about 20 to about 400 m²/g as measured by BET surface area analysis. Highly dispersed silicas having primary particle diameters of from about 5 to about 500 nm or from about 10 to about 400 nm can be utilized. These highly dispersed silicas can be prepared by, for example, precipitation of solutions of silicates or by flame hydrolysis of silicon halides. The silicas can also be present in the form of mixed oxides with other metal oxides, such as, for example, Al, Mg, Ca, Ba, Zn, Zr, Ti oxides and the like. Commercially available silica fillers known to one skilled in the art include, but are not limited to, Cab-O-Sil® silica from Cabot Corporation, Hi-Sil® and Ceptane® silica from PPG Industries; Zeosil® silica from Rhodia, Ultrasil® and Coupsil® silica from Degussa AG, and Agilon™ silicas from PPG industries. Mixtures of two or more silica fillers can be used in preparing the elastomeric composition of this invention.

When silica is utilized as the filler, the amounts can vary widely. Generally, the amount of silica filler can range from about 5 and 200 phr, about 20 and about 150 phr, and about 50 to about 120 phr.

If desired, carbon black fillers can be employed with the silica or other filler(s) in forming the elastomeric compositions of this invention. Suitable carbon black fillers include any of the commonly available, commercially-produced carbon black fillers known to one skilled in the art. The carbon black fillers, if any, are ordinarily incorporated into the elastomeric composition in amounts ranging from about 1 to about 100 phr or from about 5 to about 65 phr.

In one embodiment of the invention, carbon black having a surface area (EMSA) of at least 20 m²/g is utilized. In other embodiments, the surface area of the carbon black is at least 35 m²/g. In yet other embodiments, the surface area is 200 m²/g or higher. Surface area values used in this application are those determined by ASTM Test D-3765 using the cetyltrimethyl-ammonium bromide (CTAB) technique. Among the useful carbon black fillers are furnace blacks, channel blacks and lamp blacks. More specifically, examples of the carbon black fillers include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon black fillers, which may be utilized, include acetylene blacks. Mixtures of two or more of the above carbon black fillers can be used in preparing the elastomeric compositions of the invention. The carbon black fillers utilized in the invention may be in pelletized form or an unpelletized flocculant mass.

The elastomeric composition also contains at least one coupling agent. The coupling agent can be any that is known in the art for use in elastomeric compositions. Such coupling agents, for example, may be premixed, or pre-reacted, with the filler or added during the elastomer/filler processing, or mixing stage. If the coupling agent and filler are added separately to the elastomer during the elastomer/filler mixing, or processing stage, the coupling agent can combine in situ with the filler. In particular, such coupling agents are generally composed of a silane which has a constituent component, or moiety, (the silane portion) capable of reacting with the silica surface and, also, a constituent component, or moiety, capable of reacting with the rubber, e.g., a sulfur vulcanizable rubber which contains carbon-to-carbon double bonds, or unsaturation. In this manner, then, the coupling agent acts as a connecting bridge between the silica and the rubber thereby enhancing the rubber reinforcement aspect of the silica.

The silane component of the coupling agent may form a bond to the filler surface, possibly through hydrolysis, and the rubber reactive component of the coupling agent combines with the rubber itself. Generally, the rubber reactive component of the coupling agent is temperature sensitive and tends to combine with the rubber during the final and higher temperature sulfur vulcanization stage, i.e., subsequent to the rubber/filler/coupling agent mixing stage and after the silane group of the coupling agent has combined with the filler. However, partly because of typical temperature sensitivity of the coupling agent, some degree of combination, or bonding, may occur between the rubber-reactive component of the coupling agent and the rubber during an initial rubber/filler/coupling agent mixing stage and prior to a subsequent vulcanization stage.

Suitable rubber-reactive group components of the coupling agent include, but are not limited to, one or more of groups such as mercapto, amino, vinyl, epoxy, and sulfur groups. In other embodiments, the rubber-reactive group components of the coupling agent is a sulfur or mercapto moiety with a sulfur group being most preferable.

Examples of a coupling agent for use herein are vinyltrichlorosilane, vinyltrimethoxysilane, vinyltriethoxysilane, vinyltris(β-methoxyethoxy)silane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, -β(aminoethyl)-γ-aminopropylmethyldimethoxysilane, N-β-(aminoethyl)γ-aminopropyltrimethoxysilane, N-β(aminoethyl)γ-aminopropyltriethoxysilane, γ-aminopropyltrimethoxysilane, γ-aminopropyltriethoxysilane, -phenyl-γ-aminopropyltrimethoxysilane, γ-chloropropyltrimethoxysilane, γ-mercaptopropyltrimethoxysilane and combinations thereof.

Representative examples of the sulfur-containing coupling agents are sulfur-containing organosilicon compounds. Specific examples of suitable sulfur-containing organosilicon compounds are of the following general formula:

Z—R¹—Sₙ—R²—Z

in which Z is selected from the group consisting of

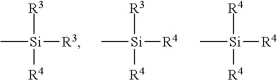

wherein R³ is an alkyl group of from 1 to 4 carbon atoms, cyclohexyl or phenyl; and R⁴ is an alkoxy of from 1 to 8 carbon atoms, or cycloalkoxy of 5 to 8 carbon atoms; and R¹ and R² are independently a divalent hydrocarbon of from 1 to 18 carbon atoms and n is an integer of from about 2 to about 8.

Specific examples of sulfur-containing organosilicon compounds which may be used herein include, but are not limited to, 3,3′-bis(trimethoxysilylpropyl)disulfide, 3,3′-bis(triethoxysilylpropyl)disulfide, 3,3-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)triasulfide, 3,3′-bis(triethoxysilylpropyl)triasulfide, 3,3′-bis(tributoxysilylpropyl)disulfide, 3,3′-bis(trimethoxysilylpropyl)hexasufide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilyl-propyl)disulfide, 2,2′-bis(methoxydiethoxysilylethyl)tetrasulfide, 2,2′-bis(tripropoxysilylethyl)pentasulfide, 3,3′-bis(tricyclohexoxysilylpropyl)tetrasulfide, 3,3′-bis(tricyclopentoxysilylpropyl)trisulfide, 2,2′-bis(tri-2″-methyl-cyclohexoxysilylethyl)tetrasulfide, bis(trimethoxysilylmethyl)tetrasulfide, 3-methoxy ethoxy propoxysilyl 3′-diethoxybutoxy-silylpropyltetrasulfide, 2,2′-bis(dimethyl methoxysilylethyl)disulfide, 2,2′-bis(dimethyl sec.butoxysilylethyl)trisulfide, 3,3′-bis(methyl butylethoxysilylpropyl)tetrasulfide, 3,3′-bis(di t-butylmethoxysilylpropyl)tetrasulfide, 2,2′-bis(phenylmethylmethoxysilylethyl)trisulfide, 3,3′-bis(diphenyl isopropoxysilylpropyl)tetrasulfide, 3,3′-bis(diphenyl cyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methyl ethoxypropoxysilylethyl)tetrasulfide, 3,3′-bis(diethyl methoxysilylpropyl)tetrasulfide, 3,3′-bis(ethyl di-sec. butoxysilylpropyl)disulfide, 3,3′-bis(propyl diethoxysilylpropyl)disulfide, 3,3′-bis(butyl dimethoxysilylpropyl)trisulfide, 3,3′-bis(phenyl dimethoxysilylpropyl)tetrasulfide, 3-phenyl ethoxybutoxysilyl 3′-trimethoxysilyipropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyl-octadecenyl)tetrasulfide, 4,4′-bis(trimethoxysilylbutene-2-yl)tetrasulfide, 4,4′-bis(trimethoxysilylcyclohexylene)tetrasulfide, 5,5′-bis(dimethoxymethyl-silylpentyl)trisulfide, 3,3′-bis(trimethoxysilyl-2-methylpropyl)tetrasulfide, 3,3′-bis(dimethoxyphenylsilyl-2-methylpropyl)disulfide and the like. The preferred coupling agents are 3,3′-bis(triethoxysilylpropyl)disulfide and 3,3′-bis(triethoxysilylpropyl)tetrasulfide.

When a coupling agent is utilized, the amount can range from about 0.1 to about 15 wt % and from about 1 to about 8% based on the weight of the filler.

When PVB is utilized as the vinyl acetal polymer, silanes may or may not be added. When utilized, silanes can be added up to 20 phr in combination with PVB or up to 20% of the filler in the formulation added in the same or different or more than one mixing stage(s).

Additionally, at least one other common additive can be added to the rubber compositions of this invention, if desired or necessary, in a suitable amount. Suitable common additives for use herein include vulcanizing agents, activators, retarders, antioxidants, compatibilizers, anti-blocking agents, plasticizing oils and softeners, fillers other than silica and carbon black, reinforcing pigments, antiozonants, waxes, tackifier resins, crosslinking resins, processing aids, carrier elastomers, tackifiers, lubricants, waxes, surfactants, stabilizers, UV absorbers/inhibitors, pigments, extenders, reactive coupling agents, and/or branchers and combinations thereof. In one embodiment, the additives comprise a non-vinyl acetal polymer processing aid. This processing aid can comprise, for example, a processing oil, and/or water. In such an embodiment, the elastomeric composition can comprise a processing aid in an amount less than 50 phr, based on the total weight of the elastomers. In other embodiments, the amount of processing aid ranges from less than 40 phr, less than 30 phr, less than 20 phr, and less than 10 phr, based on the total weight of the elastomers. Additionally or alternatively, the elastomeric composition can exhibit a weight ratio of vinyl acetal polymer to processing aid of at least about 0.5:1, 1:1, 2:1, 3:1, 4:1, 5:1, 8:1, or 10:1.

The compositions according to the present invention may be vulcanized according to known techniques, and in particular with sulfur-based vulcanizing systems commonly employed for diene elastomers. To this end, after the first few thermal-mechanical working (mixing) steps, a sulfur-based vulcanizing agent is incorporated in the composition together with vulcanization activators and accelerators. In this working step, the temperature is generally kept below 120° C., preferably below 100° C., to prevent undesired pre-cross-linking phenomena.

A process is also provided to produce the elastomeric composition. The process comprising mixing at least one elastomer, at least one vinyl acetal polymer, at least one filler, and at least one coupling agent. The mixing can be accomplished by any method that is known in the art that is adequate to disperse the vinyl acetal polymer. Mixing may be carried out for instance by means of an open-mill type mixer, or by means of an internal mixer of the type with tangential (Banbury) or interpenetrating (Intermix) rotors, or in continuous mixers of the Ko-Kneader (Buss) type, or of twin-screw co-rotating or counter-rotating type. Also, any of the fillers and vinyl acetal polymers may be pre-mixed into a carrier elastomer base to make a concentrated batch and then mixed with the final formulation. The elastomer of the concentrated batch can be the same or different than the elastomer or elastomers used in the elastomeric compositions. The mixing and addition sequences for the components can vary.

The elastomeric compositions of the present invention can be incorporated into various types of end products.

In certain embodiments, the elastomeric composition is formed into a tire and/or a tire component. The tire component can comprise, for example, tire tread, subtread, undertread, body plies, belts, overlay cap plies, belt wedges, shoulder inserts, tire apex, tire sidewalls, bead fillers, and any other tire component that contains an elastomer. In one embodiment, the elastomeric composition is formed into tire tread, tire sidewalls, and/or bead fillers. These include the tread, sidewall, and carcass portions intended for, but not exclusive to, a truck tire, passenger tire, off-road vehicle tire, vehicle tire, high speed tire, and motorcycle tire that also contain many different reinforcing layers therein. Such rubber or tire tread compositions in accordance with the invention may be used for the manufacture of tires or for the re-capping of worn tires.

In certain embodiments, the elastomeric composition is incorporated into non-tire applications. Non-tire applications include, for example, a blowout preventer, fire hoses, weather stripping, belts, injection molded parts, footwear, pharmaceutical closures, plant lining, flooring, power cables, gaskets, seals, and architectural trims. In particular, the cellulose ester/elastomer compositions can be utilized in various oil field applications such as, for example, blowout preventers, pump pistons, well head seals, valve seals, drilling hoses, pump stators, drill pipe protectors, down-hole packers, inflatable packers, drill motors, O-Rings, cable jackets, pressure accumulators, swab cups, and bonded seals.

Unlike the other solutions described in the previous section, adding a vinyl acetal polymers to filler tire formulations simultaneously improves its processing and subsequently μ of the final vulcanized compound. Additionally, unlike the crosslinking resins listed above, the μ enhancements achieved may not deteriorate significantly during the life of the tire.

This invention achieves simultaneous improvements in processing of tire compounds and subsequent μ (ratio of G′ from RPA @ 5% strain to M300 modulus) characteristics in tires made using these compounds without significantly deteriorating other tire physical and performance characteristics. Most mechanical properties improve when vinyl acetal polymer is used in the formulation. In addition, manufacturing is improved as mixing time and or energy utilization may as well be reduced.

### EXAMPLES

The following test methods were utilized in these examples to determine properties of elastomeric compositions.

Cure Rheometer: Oscillating Disk Rheometer (ODR) was performed according to ASTM D 2084. Tₛ2 is the time it takes for the torque of the rheometer to increase 2 units above the minimum value. T_{c}90 is the time to reach 90% of the difference between minimum to maximum torque.

The Mooney Viscosities were measured according to ASTM D 1646.

Hot Molded Groove Trouser Tear (at 100° C.): Molded groove trouser tear (Type CP modified trouser tear test piece with a constrained path for tear) was performed according to ASTM test method D624.

Break stress and break strain were measured as per ASTM D412 using Die C for specimen preparation. The speed of testing was 20 inches/min, and the gauge length was 63.5 mm (2.5 inch). The samples were conditioned in the lab for 40 hours at 50%+/−5% humidity and 72° F. The width of the specimen was 1 inch, and length was 4.5 inch.

Dynamic Mechanical Analysis (Temperature Sweeps): 1) Instrument DMA Q800 V20.26 Build 45 was used in tensile mode to perform the temperature sweep experiment. The experimental conditions were 1 Hz with 5% dynamic strain. The heating rate of 3° C./minute was used for a temperature range of −30° C. to 60° C. after a 10 minute hold at −30° C.

### Examples 1-6

Tire performance parameters were determined for the tire compositions containing vinyl acetal polymers having formulations as shown in Table 1. Processing steps for producing the elastomeric compositions are shown in Table 2. Examples C1-C2 and C5-C6 were comparative examples where no vinyl acetal polymer was utilized. I3 and I4 were the inventive examples. Examples C5 and C6 utilized cellulose ester additive (CEA) rather than vinyl acetal polymers.

TABLE 1
Formulations of tire tread compounds containing select polymers as additives

| | | Examples | | | | | |
|---|---|---|---|---|---|---|---|
| Ingredients | Description | C1 | C2 | I3 | I4 | C5 | C6 |
| | | Stage 1 mix conditions | | | | | |
| Buna ® VSL 5025-2¹ | S-SBR, 37.5phr | 89.38 | 89.38 | 89.38 | 89.38 | 89.38 | 89.38 |
| | TDAE, high vinyl | | | | | | |
| | (67 wt % of | | | | | | |
| | butadiene; 25 wt % | | | | | | |
| | Sulfur) | | | | | | |
| Buna ® CB24² | PBD rubber | 35 | 35 | 35 | 35 | 35 | 35 |
| Ultrasil ® 7000 GR³ | Silica | 65 | 65 | 65 | 65 | 65 | 65 |
| Continex ®N234⁴ | Carbon Black | 15 | 15 | 15 | 15 | 15 | 15 |
| ~Si 266⁵ | Struktol SCA 985 | 5.07 | 5.07 | 5.07 | 5.07 | 5.07 | 5.07 |
| Zinc oxide | Cure activator | 1.9 | 1.9 | 1.9 | 1.9 | 1.9 | 1.9 |
| Okerin ® wax 7240⁶ | microcrystalline wax | 1.5 | 1.5 | 1.5 | 1.5 | 1.5 | 1.5 |
| Santoflex ® 6PPD⁷ | 6PPD | 2 | 2 | 2 | 2 | 2 | 2 |
| Stearic acid | Cure Activator | 1.5 | 1.5 | 1.5 | 1.5 | 1.5 | 1.5 |
| Product of Stage 1 | MB1 | 216.35 | 216.35 | 216.35 | 216.4 | 216.4 | 216.4 |
| | | Stage 2 mix conditions | | | | | |
| Masterbatch | MB1 | 216.35 | 216.35 | 216.35 | 216.4 | 216.4 | 216.4 |
| Ultrasil 7000 GR | Silica | | 5 | | | | |
| ~Si 266 | Struktol ® SCA 985 | | 0.39 | | | | |
| Polyvinyl | Polymer | | | 5 | | | |
| butyral (PVB) | | | | | | | |
| Polyvinyl | Polymer | | | | 5 | | |
| formal (PVF) | | | | | | | |
| CEA1⁸ | Polymer | | | | | 5 | |
| CEA2⁹ | Polymer | | | | | | 5 |
| Product of stage 2 | MB2 | 216.35 | 221.74 | 221.35 | 221.4 | 221.4 | 221.4 |
| | | Stage 3 (productive) mix conditions | | | | | |
| Masterbatch | MB2 | 216.35 | 221.74 | 221.35 | 221.4 | 221.4 | 221.4 |
| Sulfur | Cross-linker | 1.28 | 1.28 | 1.28 | 1.28 | 1.28 | 1.28 |
| CBS¹⁰ | Accelerator | 1.1 | 1.1 | 1.1 | 1.1 | 1.1 | 1.1 |
| DPG¹¹ | Accelerator | 1.28 | 1.28 | 1.28 | 1.28 | 1.28 | 1.28 |
| Total | | 220 | 225.4 | 225 | 225 | 225 | 225 |

¹Solution Styrene Butadiene Rubber obtained from Lanxess containing treated distillate aromatic extract.
²Polybutadiene Rubber obtained from Lanxess.
³Silica obtained from Evonik Industries.
⁴Carbon black obtained from Continental Carbon.
⁵Silane coupling agent obtained from Struktor Company.
⁶Microcrystalline wax obtained from Sovereign Chemical.
⁷Anti-oxidant obtained from Flexsys.
⁸Cellulose Acetate Butyrate Additive 1 obtained from Eastman Chemical Company.
⁹Cellulose Acetate Propionate Additive 2 obtained from Eastman Chemical Company
¹⁰n-cyclohexyl-2-benzothiazole
¹¹diphenyl guanidine

TABLE 2
Processing of tire tread compounds containing
select polymers as additives
Stage 1 mix conditions (settings)

| | |
|---|---|
| start temperature | 149° F. |
| starting rotor | 65 |
| speed, rpm | |
| fill factor | 70% |
| ram pressure | 50 |
| (psi) | |
| mix sequence | at 0 minutes add elastomers |
| | at 15 seconds add ⅔ silica + Si266 |
| | at 45 seconds add ⅓ silica + others |
| | at 1.5 minutes sweep |
| | Raise temp to 320° F. in 3.0 minutes |
| dump conditions | hold 30 seconds at 320° F. (total mix time = 3.5 |
| | minutes) |
| Mill Conditions | 50° C. mill with knife flips for 1 minute |

Stage 2 mix conditions (settings)

| | |
|---|---|
| start temperature | 149° F. |
| starting rotor | 65 |
| speed, rpm | |
| fill factor | 67% |
| ram pressure | 50 |
| (psi) | |
| mix sequence | at 0 minutes add ½ of first pass batch |
| | at 15 seconds add other ingredients in a low-melt bag |
| | and ½ of first pass batch. |
| | at 1 minute sweep. |
| | at 1.5 minute adjust (increase) rotor speed, ramp |
| | temperature to 320° F. in 80 to 90 seconds |
| dump conditions | Hold 2 minutes or more at 320° F. to keep total mix |
| | time = 5.0 minutes |
| Mill Conditions | 50° C. mill with knife flips for 1 minute |

Stage 3 (productive) mix condtions (settings)

| | |
|---|---|
| start temperature | 122° F. |
| starting rotor | 60 |
| speed, rpm | |
| fill factor | 64% |
| ram pressure | 50 |
| (psi) | |
| addition order | at 0 minutes 2nd pass batch, at 15 seconds add sulfur, |
| | accelerator pocket, sweep at 1 minute. |
| dump conditions | Raise to 194-212° F., hold till total mix time = 2 |
| | minutes 30 seconds unless temp goes above 230° F. |
| Mill Conditons | RT mill with knife flips for 1 minute |

### A) Performance

TABLE 3
Performance of tire tread compounds containing select polymers as additives

| | | Mooney | | | | | | | | | | | | | | |
|---|---|---|---|---|---|---|---|---|---|---|---|---|---|---|---|---|
| | Initial | ML | Ini. | Mooney | | | | | | | | | | | | |
| | Mooney | (1 + 4) | Mooney | Day 8 | | Break | Mod | Mod | | γ^{b} | G′ at | | | | | |
| | Day 2 | Day 2 | Day 8 | (1 + 4) | TS^{a} | strain | 100% | 300% | G′ at | (kPa/ | −20 C. | tanδ | tanδ | tanδ | Ts2 | T90 |
| Ex. | (MU) | (MU) | (MU) | (MU) | (MPa) | (%) | (MPa) | (MPa) | 60° C. | Mpa) | (kPa) | 0° C. | 30° C. | 60° C. | (min) | (min) |
| 1 | 123.9 | 91.90 | 157.80 | 96.90 | 19.50 | 482.44 | 2.05 | 9.95 | 2610 | 262.26 | 9298 | 0.51 | 0.26 | 0.19 | 1.84 | 18.12 |
| 2 | 142.7 | 103.10 | 184.70 | 108.50 | 17.83 | 408.20 | 2.61 | 11.86 | 3005 | 253.30 | 10710 | 0.51 | 0.28 | 0.20 | 1.74 | 22.63 |
| 3 | 105.3 | 82.60 | 123.90 | 86.20 | 14.32 | 450.08 | 1.76 | 7.93 | 2692 | 339.36 | 10440 | 0.57 | 0.34 | 0.26 | 2.10 | 11.34 |
| 4 | 112.2 | 87.40 | 138.70 | 92.20 | 16.56 | 494.44 | 1.90 | 8.13 | 3661 | 450.17 | 10070 | 0.52 | 0.31 | 0.25 | 1.60 | 11.55 |
| 5 | 113.9 | 86.00 | 140.80 | 91.00 | 19.34 | 529.50 | 1.93 | 8.59 | 2452 | 285.47 | 10120 | 0.54 | 0.30 | 0.23 | 2.19 | 14.71 |
| 6 | 119.2 | 89.70 | 147.10 | 94.70 | 17.80 | 492.14 | 2.07 | 8.86 | 2645 | 298.58 | 10400 | 0.52 | 0.29 | 0.22 | 2.07 | 15.61 |

^{a}TS = tensile strength
^{b}γ (kPa/MPa) = ratio of G′ from RPA @ 5% strain to M300 modulus

Example 1 is a comparative example. Thermoplastic polymers were added to the formulation of Example 1 at 5 phr loading in Examples 3 through 6 to demonstrate performance enhancements. Example 2 was another comparative example which contains 5 phr of silica additionally added to the Example 1 formulation.

In Inventive Examples 3 and 4 containing polyvinyl butyral (PVB) and polyvinyl formal (PVF) respectively, the initial Mooney viscosity values did not change significantly on storage as compared to Comparative Examples 1 and 2 which had a significant increase. Increase in initial viscosity limits the storage life span of elastomeric compositions. The addition of the vinyl acetal polymers helps to increase the storage time before elastomeric compositions are processed further. Also, ascribed to the low initial viscosities these compounds start at lower viscosities with a possibility of significantly reducing the time and energy required in their re-milling to a desired viscosity. Also, the ML(1+4), which is a plateau value after 4 minutes of test values, were significantly lower than Comparative Examples 1 and 2 indicating possible reduction in number of mixing stages and mixing time of the elastomeric compositions.

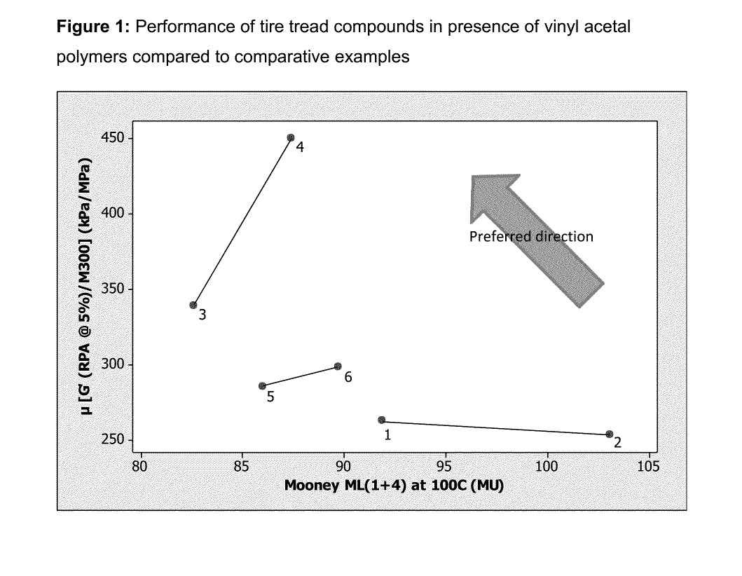

Handling properties showed substantial increase through the increase in G′ values when vinyl acetal polymers were present. FIG. 1 shows the increase in G′ values. Scorch time for elastomeric compositions containing PVB (Example 3) was improved whereas cure time dropped compared to comparative formulations when PVB and PVF are not present in the elastomeric compositions.

Compared to Examples 1 and 2, CEA containing formulations (Examples 5 and 6) showed lower Mooney viscosity and enhanced μ simultaneously. See FIG. 1 below. However, PVB and PVF containing formulations (Examples 3 and 4) demonstrated much higher increase in μ than the comparatives and CEA containing examples. Parameter μ′ can be related to the handling performance of the tires fabricated from these formulations, where higher values are considered better. Example 3 containing PVB demonstrated the maximum benefit in terms of Mooney viscosity which directly relates to the ease of processability of elastomeric formulations such as in the case of tires. The desired Mooney viscosity for a given application can be achieved by tuning the formulation and processing parameters. The change in initial Mooney viscosities (that correlate with the extent of filler agglomeration) during storage, indicate less change (increase in viscosity) in examples having vinyl acetal polymers compared to comparatives and CEA containing examples. Increase in initial viscosity limits the storage life span on mixed compounds. Thus, incorporation of vinyl acetal polymers in formulations facilitates longer storage time for the mixed formulations.

That which is claimed:

1. An elastomeric composition comprising at least one elastomer, at least one vinyl acetal polymer, at least one filler, and optionally at least one coupling agent.

2. The elastomeric composition according to claim 1 wherein said elastomer is selected from the group consisting of natural rubber, a modified natural rubber, a synthetic rubber, and mixtures thereof.

3. The elastomeric composition according to claim 1 wherein at least one of the elastomers is a non-polar elastomer.

4. The elastomeric composition according to claim 3 wherein said non-polar elastomers are selected from the group consisting of natural rubber, polybutadiene rubber, polyisoprene rubber, butyl rubber, styrene-butadiene rubber, polyolefins, ethylene propylene monomer rubber (EPM), ethylene propylene diene monomer (EPDM) rubber, and polynorbornene rubber.

5. The elastomeric composition according to claim 1 wherein said vinyl acetal polymer structure is: 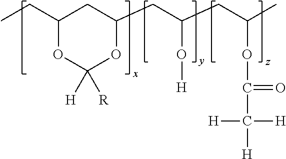
wherein the R group is hydrogen or a linear or branched alkyl functionality having from 1 to 5 carbons atoms.

6. The elastomeric composition according to claim 5 wherein said vinyl acetal polymer has about 25 wt % to about 95 wt % of vinyl acetal monomer units, from about 2 wt % to about 40 wt % vinyl alcohol monomer units, and 0 wt % to 40 wt % vinyl acetate monomer units.

7. The elastomeric composition according to claim 1 wherein said vinyl acetal polymer is polyvinyl formal and wherein said polyvinyl formal has about 25 wt % to about 95 wt % of vinyl acetal monomer units, from about 2 wt % to about 40 wt % vinyl alcohol monomer units, and 0 wt % to 40 wt % vinyl acetate monomer units.

8. The elastomeric composition according to claim 1 wherein the vinyl acetal polymer is polyvinyl butyral and wherein said polyvinyl butyral has about 25 wt % to about 95 wt % of vinyl acetal monomer units, from about 2 wt % to about 40 wt % vinyl alcohol monomer units, and 0 wt % to 40 wt % vinyl acetate monomer units.

9. The elastomeric composition according to claim 5 wherein said vinyl acetal polymer has about 70 wt % to about 95 wt % of vinyl acetal monomer units, from about 4 wt % to about 25 wt % vinyl alcohol monomer units, and 0 wt % to 15 wt % vinyl acetate monomer units.

10. The elastomeric composition according to claim 1 wherein the molecular weight of said vinyl acetal polymer ranges from about 1 kDa to about 600 kDa.

11. The elastomeric composition according to claim 1 wherein said vinyl acetal polymer is polyvinylbutryal.

12. The elastomeric composition according to claim 1 wherein the amount of said vinyl acetal polymer ranges from about 1 to about 30 phr

13. The elastomeric composition according to claim 1 further comprising at least one additive; wherein said additive is selected from the group consisting of vulcanizing agents, activators, retarders, antioxidants, compatibilizers, anti-blocking agents, plasticizing oils and softeners, fillers other than silica and carbon black, reinforcing pigments, antiozonants, waxes, tackifier resins, crosslinkable resins, processing aids, carrier elastomers, tackifiers, lubricants, waxes, surfactants, stabilizers, UV absorbers/inhibitors, pigments, extenders, reactive coupling agents, and/or branchers and combinations thereof.

14. The elastomeric composition according to claim 1 wherein said filler is selected from the group consisting of silica, carbon black, clay, alumina, talc, mica, discontinuous fibers including cellulose fibers and glass fibers, aluminum silicate, aluminum trihydrate, barites, feldspar, nepheline, antimony oxide, calcium carbonate, kaolin, and combinations thereof.

15. The elastomeric composition according to claim 1 wherein the amount of filler in said elastomeric composition ranges from about 1 to about 400 phr.

16. The elastomeric composition according to claim 1 wherein said coupling agent has a silane portion and a rubber reactive portion.

17. The elastomeric composition according to claim 16 wherein said rubber reactive portion is a functional group selected from the group consisting mercapto, amino, vinyl, epoxy, and sulfur groups.

18. The elastomeric composition according to claim 1 wherein said vinyl acetal polymer is polyvinylbutyral, and wherein said filler is silica and/or carbon black.

19. An article comprising the elastomeric composition of claim 1.

20. A tire comprising the elastomeric composition of claim 1.
